(19) United States
(12) Patent Application Publication
(10) Pub. No.: US 2023/0005001 A1
(43) Pub. Date: Jan. 5, 2023

(54) SYSTEM FOR AUTOMATED AND DYNAMIC PRICING AND DONATION

(71) Applicant: Thrift for Good, Ltd., Fort Worth, TX (US)

(72) Inventors: Allen Taylor Watts, Bedford, TX (US); Jennifer Cocanougher-Cooper, Bedford, TX (US); John Wesley Cooper, III, Bedford, TX (US)

(21) Appl. No.: 17/810,304

(22) Filed: Jun. 30, 2022

Related U.S. Application Data
(60) Provisional application No. 63/202,993, filed on Jul. 2, 2021.

(51) Int. Cl. G06Q 30/02

(52) U.S. Cl. CPC G06Q 30/0206

(57) ABSTRACT

A system for dynamic pricing of secondhand goods comprising: a tag corresponding to an item, a database for hosting information regarding a plurality of items, a software capable of comparing items within the system and identifying a sale price, a location for placing the item for sale; placing an item for sale and dynamically raising or lowering the price of the item for sale as the information in the database is modified.

### CROSS-REFERENCE TO RELATED APPLICATIONS

This application claims the benefit of U.S. Provisional Patent Application No. 63/202,993 filed on Jul. 2, 2021, with the United States Patent and Trademark Office, the contents of which are incorporated herein by reference in their entirety.

### FIELD OF THE INVENTION

The system and methods detailed herein address dynamic pricing, inventory, and sales metrics, while simultaneously providing for individualized donation options for goods provided into secondhand goods.

### BACKGROUND OF THE INVENTION

Thrift stores and secondhand shops exist throughout the country in various forms. Many thrift stores take donations of goods from the public, sort, and price the goods and then resell the goods to the public with the profits benefitting that store's designated charity. If donors wish to take a charitable tax deduction for their contribution, the donor is responsible for assessing the fair market value of the goods donated. There is little guidance for the fair market value assessment creating liability for the donor and the donation only benefits the designated charity of the thrift store.

Thrift stores likewise face challenges in managing their inventory and having accurate data to show how quickly a particular category of items sell or the profit margin for a particular category of goods. Thrift stores that operate nationally lack a mechanism for moving inventory to regions where the particular item may sell more quickly or command a greater value, and for knowing the specific value of brands or features as they compare to one another. Traditional thrift stores also lack the ability to capitalize on the wholesale marketplace as certain donated items may retail for more value in a specialty used goods store rather than a thrift store. Currently, specialty and vintage store owners often need to physically search the inventories of brick and mortar thrift stores rather than being able to access a digital wholesale marketplace where they can purchase inventory for their own store.

On the donor side, the need exists for a person to be able to donate goods to a thrift store with the proceeds going to any charity that the person designates. On the retail side, the need exists for a robust inventory management system that provides for inventory tracking, sales analytics, an online marketplace, ease of pricing a large quantity of unique items and the ability to wholesale items. These and other elements are provided for and detailed by the following embodiments.

### SUMMARY OF THE INVENTION

The embodiments of the present disclosure address systems and methods for significantly increasing efficiency in the pricing, cataloguing, and operations of retail goods, and specifically toward secondhand goods.

In a preferred embodiment, a system for dynamic pricing of secondhand goods comprising: a tag corresponding to an item, a database for hosting information regarding a plurality of items, a software capable of comparing items within the system and identifying a sale price, and a location for placing the item for sale; and placing an item for sale and dynamically raising or lowering the price of the item for sale as the information in the database is modified.

In a further embodiment, a method for dynamically pricing secondhand goods comprising: (a) generating a database containing a list of price entries within the database, said database comprising keywords to group similar items; (b) creating a new entry for an item comprising a keyword for said item; (c) performing a search within the database on the keyword of the item; (d) returning a sale price and a location for said item; (e) pricing said item; and (f) updating the search regarding said keyword on a dynamic basis, wherein upon a variation of an average sale price of more than a predefined amount, modifying the price of said item.

In a further preferred embodiment, the method further comprising modifying the price of an unsold item within the database that comprises the same keyword.

In a further preferred embodiment, the method further comprising a tag on said item. In a further preferred embodiment, the method further comprising wherein the database record is accessible by scanning the tag on said item; and scanning the tag on said item to access said database and modifying the price within the database. In a further preferred embodiment, the method further comprising printing a new tag with the modified price and affixing the same to the item. In a further preferred embodiment, the method further comprising scanning said tag, taking a photo of said item, and uploading the photo to said item to said database. The scan to modify function will also be used to check to see whether an item has been out too long and needs a discount, to assign item type (so we can pull an inventory report and know how much we need to restock), to assign merchandiser (to assess worker productivity), and to edit other parts of the item like its description

In a further preferred embodiment, the method wherein the photo in said database is linked to an e-commerce Web site, wherein upon uploading of the photo into the database the photo is visible on said e-commerce Web site.

In a further embodiment, a method of pricing donated goods comprising: (a) creating a lot number related to a series of donated goods; (b) entering each of the goods within the lot to an entry corresponding to the lot number; (c) creating an individual entry for each of the goods within the lot; and (d) creating an individual tag for each of the goods within the lot.

In a further preferred embodiment, the method further comprising: (e) querying a database for each item and determining a price based on an average sale price of items in the database that correspond to the item to be priced; and (f) creating a label to affix to said item. In preferred embodiments, step (e) is further defined by a goal number of days on the market determination, which queries the database to modify the price by dynamic pricing based upon the price of the item and the goal number of days on the market, wherein modification of the price to hit the goal number of days on the market yields a modified price.

In a further preferred embodiment, the method further comprising scanning said tag when the item is being placed for sale; and updating the database with a time, a date, and a location of the item for sale.

In a further preferred embodiment, the method further comprising updating the database with a sale price, a sale date, and a sale time upon realizing a sale of the item.

In a further embodiment, a method of maximizing sale price of donated goods comprising: (a) creating a database of items, each item provided with a series of identifiable key words to group similar items; (b) entering a new item into the database and querying the database for an average sale price of items with the same keyword; (c) determining the highest sale price of said item and a location of the highest sale price; (d) determine a cost of shipping said item to realize the highest sale price; (e) calculating the highest sale price, minus the cost of shipping and handling of said item; and (f) listing said item for sale based upon the calculated highest sale price.

In a further embodiment, a method of providing donations to a predetermined charitable organization comprising: (a) receiving a lot of items; (b) creating a lot number corresponding to said lot; (c) creating an entry in a database to said lot and identifying the charitable organization to benefit from sale of said items; (d) listing said items for sale; and (e) providing a donation to said charitable organization based on a percentage of a realized sale price of said items.

In a preferred embodiment, a system for dynamic pricing of secondhand goods comprising: a database comprising a plurality of entries; a tag corresponding to an item; a software capable of comparing the item to the plurality of entries within the database and providing a goal number of days on market and a price to meet said goal number of days on market; and placing an item for sale and dynamically raising or lowering the price of the item for sale as information in the database is modified.

In a further embodiment, the system wherein dynamically raising or lowering the price of the item for sale is performed by a process comprising: (a) comparing the goal number of days on market to an actual number of days on market from at least one sale within the database; (b) determining a difference between the goal number of days on market and the actual number of days on market; (c) taking the difference between the goal number of days on market and the actual number of days on market and multiplying the difference by a price factor to yield a price modification figure; and (d) modifying the price by the price modification figure.

In a further embodiment, the system wherein the goal number of days on market is defined as a number between 1 day and 365 days; and wherein the goal number of days on market is determined by a base number of days on market added to the price and multiplied by a factor of days on market to yield the goal number of days on market.

In a further embodiment, the system wherein an adjustment based on the dynamic pricing is made based upon a sale being above or below the goal number of days on market.

In a further embodiment, the system wherein the dynamic pricing is modified by an adjustment value multiplied by a number of days separated from the goal number of days on market and then added or subtracted from the price.

In a further embodiment, the system wherein the system further defines a location for placing the item for sale.

In a further embodiment, the system wherein the location is within a single store. In a further embodiment, the system wherein the location is an online marketplace.

In a preferred embodiment, a method for dynamically pricing goods comprising: (a) creating a new database entry within a database for an item, said database entry comprising a keyword related to said item; (b) performing a search within the database for the keyword of the item, said database comprising at least a sale price and a value corresponding to a number of days on market for each database entry; (c) returning a target sale price for said item; (d) pricing said item; and (e) upon passage of time, rerunning the search regarding said keyword on a dynamic basis wherein upon a variation of a sale price or the number of days on market, modifying the price of the item.

In a further embodiment, the method wherein the keyword defines a grouping of similar items and an average sale price to be used in calculating the target sale price.

In a further embodiment, the method wherein a modification of the average sale price of more than a predetermined amount modifies the pricing of said item. In a further embodiment, the method wherein the predetermined amount is between 1% of the sale price of the item and 50% of the sale price of the item. In a further embodiment, the method wherein the predetermined amount is calculated based upon sales from between 1 hour and 30 days. In a further embodiment, the method of any one wherein the predetermined amount is calculated based upon sales from between 1 day and 15 days.

In a further embodiment, the method further comprising modifying the sale price of an unsold item within the database that comprises the same keyword. In a further embodiment, the method further comprising a tag on said item.

In a further embodiment, the method further comprising wherein the database is accessible by scanning the tag on said item; and scanning the tag on said item to access said database and modifying the sale price within the database.

In a further embodiment, the method further comprising printing a new tag with the modified sale price and affixing the new tag to the item. In a further embodiment, the method further comprising scanning said tag, taking a photo of said item, and uploading the photo of said item to said database.

In a further embodiment, the method wherein the photo in said database is linked to an e-commerce Web site, wherein upon uploading of the photo into the database the photo is visible on said e-commerce Web site. In a further embodiment, the method wherein the taking of a photo is performed via a GUI that uploads the photo into the database corresponding to the tag on the item.

In a preferred embodiment, a method of pricing a group of donated goods comprising: (a) creating a lot number related to a lot comprising the group of donated goods; (b) entering each of the donated goods within the lot to an entry corresponding to the lot number; (c) creating an individual entry for each of the donated goods within the lot; (d) querying a database for each of the donated goods and determining a price based on an average sale price and a goal number of days on market as determined from them database that corresponds to the donated good to be priced; and (e) creating an individual tag for each of the donated goods within the lot to affix to said donated good.

In a further embodiment, the method further comprising scanning said tag when the donated good is being placed for sale; and updating the database with a time, a date, and a location of the donated good for sale. In a further embodiment, the method further comprising: (f) updating the database with a sale price, a sale date, and a sale time upon realizing a sale of the donated good.

In a preferred embodiment, a method of maximizing sale price of donated goods comprising: (a) creating a database of items, each item provided with at least one keyword to group similar items; (b) entering a new item into the database and querying the database for an average sale price of items with the same keyword; (c) determining a highest sale price of said item and a location of the highest sale price; (d) determine a cost of shipping and handling for said item to realize the highest sale price; (e) calculating the highest sale price minus the cost of shipping and handling of said item; and (f) listing said item for sale based upon the calculated highest sale price at the location determined by the highest sale price minus the cost of shipping and handling.

In a preferred embodiment, a method of providing donations to a predetermined charitable organization comprising: (a) receiving at least one item as a donation within a lot of items; (b) creating a lot number corresponding to said lot; (c) creating an entry in a database to said lot wherein each of the at least one item within the lot comprises an individual entry within the database, and wherein the database for the lot further comprises identifying the charitable organization to benefit from sale of the at least one item; (d) listing said at least one item for sale; and (e) providing a donation to said charitable organization based on a percentage of a realized sale price of said items.

In a preferred embodiment, a method of dynamic pricing for an item comprising: (a) creating an entry within a database corresponding to a first item; (b) said database comprising at least one second item, wherein said first item and said at least one second item comprise a common keyword within each respective database entry; (c) determining from the database an average sale price and a number of days on market for the at least one second item; (d) calculating at least an initial sale price based on the average sale price of the at least one second item; (e) determining a goal number of days on market by calculating a base number of days on market constant plus a product of the sale price and a factor of days; (f) comparing the determined goal number of days on market to an actual number of days on market for the at least one second item; (g) modifying the sale price of a product by summing the price with the product of a difference between the determined goal number of days on market and the actual number of days on market for the at least one second item and a pricing constant; and (h) placing the item for sale at the modified sale price.

In a further embodiment, the method wherein the modified sale price is updated upon the sale of any at least one second item. In a further embodiment, the method wherein the base number of days on market constant is between 1 day and 60 days, wherein the factor of days is a constant between 0.1 days and 10 days, and wherein the pricing constant is determined as between 1% and 50% of a value of the average sale price of goods in a store.

### BRIEF DESCRIPTION OF THE FIGURES

FIG. 1 depicts an overview of a simplified system comprising donations.

FIG. 2 depicts a detailed overview of a process for creating a donation based on a variety of donated goods.

FIG. 3 depicts an overview of an embodiment of the system and methods herein for adding information regarding a donated item to a database.

FIG. 4 depicts a flowchart of determining an optimized donation plan for a donated item.

FIG. 5 depicts a flowchart of a plurality of retail stores for use in a query for maximizing item value of a donated item.

FIG. 6 depicts a flowchart of dynamic pricing.

FIG. 7 depicts an embodiment of lot processing.

FIG. 8 depicts an embodiment utilizing scanning to modify a record.

FIG. 9 depicts an example of a graphical user interface for use in merchandising.

### DETAILED DESCRIPTION OF THE INVENTION

Various embodiments are described more fully hereinafter with reference to the accompanying drawings, which form a part hereof, and which show, by way of illustration, specific exemplary embodiments by which the innovations may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media, devices, or any similar or equivalent arrangements known to those skilled in the art. Accordingly, the various embodiments may take the form of an entirely hardware embodiment, an entirely software embodiment or an embodiment combining software and hardware aspects. The following detailed description is, therefore, not to be taken in a limiting sense.

As used herein, the below terms will have the following meanings as may be supplemented elsewhere in this specification:

As used in this application, the words “a,” “an,” and “one” are defined to include one or more of the referenced items unless specifically stated otherwise. The terms “approximately” and “about” are defined to mean ±10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application.

When items are provided for donation to a nonprofit organization, the donor has to evaluate a fair price for the donated goods to claim the tax benefit of the donation. However, as many know, the actual price is both easily overestimated and also underestimated. Many goods are virtually worthless, except for their intrinsic value as a consumable or necessary good, while others are highly collectible or have material value for any number of reasons. Thus, many donors end up with a complete guess at the value of their donated goods.

At a secondhand store retail location, upon receipt of a set of donated goods, the donated goods are frequently sorted and then provided with a price. Pricing is typically performed by employees at the retail location. However, even experienced employees and owners within a secondhand business may not always recognize the value or lack of value of certain items. There may be an assumption, for example, that brand name jeans have a value of x, when their real value is y. Furthermore, the realized sales price of those same brand name jeans may differ based on the location and their presentation, among other factors, even within the same physical store. This may mean that the brand name jeans were undervalued or overvalued, a faster sale could have been achieved, or that a better realized sale price could have been obtained by selling the item in another forum, for example, a different location within the store, a different store altogether, or in an online marketplace.

In some instances, certain items may be dramatically undervalued, such as collectible items. Without specific knowledge of such items, pricing them properly becomes a difficult, if not impossible task. The systems and methods detailed herein provide for a dramatically improved implementation of point of sale and cataloging systems and methods, which take a process that ordinarily takes several minutes per item to one which can be performed in mere seconds. The embodiments herein further solve the issue of generating sales data within the system that calculates and provides information for pricing and location-based sales, which would have been cumbersome and time consuming to locate and yields dynamic pricing to improve pricing and overall return.

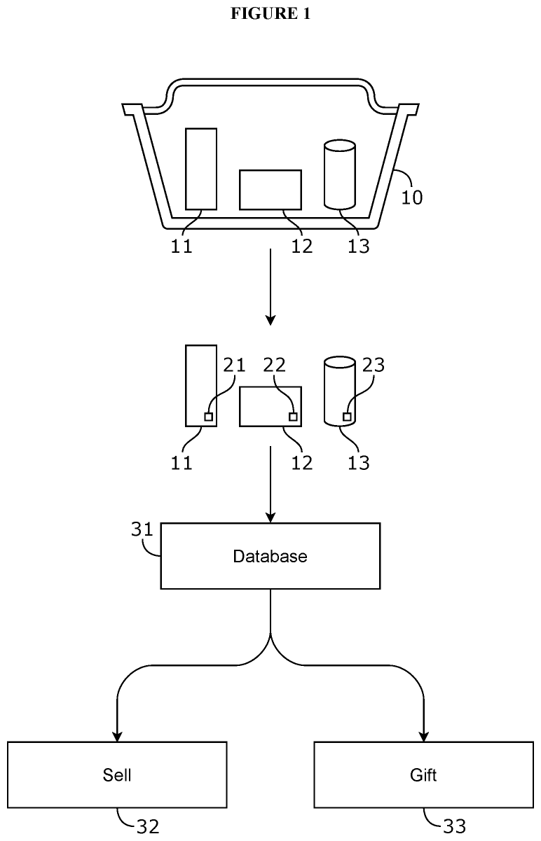

FIG. 1 outlines an embodiment in a flowchart of a donation system. The system is exemplified here with three items in a box, but the embodiments are not so limited. Thus, a box of goods (10) is donated, and contains items (11, 12, and 13). The items (11, 12, and 13) are collected in a variety of ways. Donors can drop goods off to the physical thrift store or donation center, goods can be picked up from a location designated by the donor via truck, or donors can drop off goods to a donation bin. As a second step, once the goods have been received, a tag is affixed to each item, for example tags (21, 22, and 23). The tags, e.g., tag (21), specifically identify the donated item (11) and at least some minimal information, which may include but is not limited to the name of the donor, the location and date of donation, a description of the item (e.g., size, color, other physical characteristics, etc.). This information is then added into a database (31). The database (31) entry includes the donor's name, the donors contact information, and the donor designates the charity to which proceeds from the sale of the goods will be donated. The donation information provided by the donor can be as simple as a mark on a box of donations with a charitable name, or the donor can fill out a form to be left with the donated items (in a batch lot, for example), or the donor can tell someone, who can record that information, or an electronic form can be used. The donor information and charity information are logged into a database for each individual item that is provided by the donor. In certain instances, the system or employees will determine that the value of the goods means that the items do not have sufficient value to be cataloged and sold and should be gifted to a separate charitable organization. Thus, some goods are sent to be sold (32) while others are gifted (33).

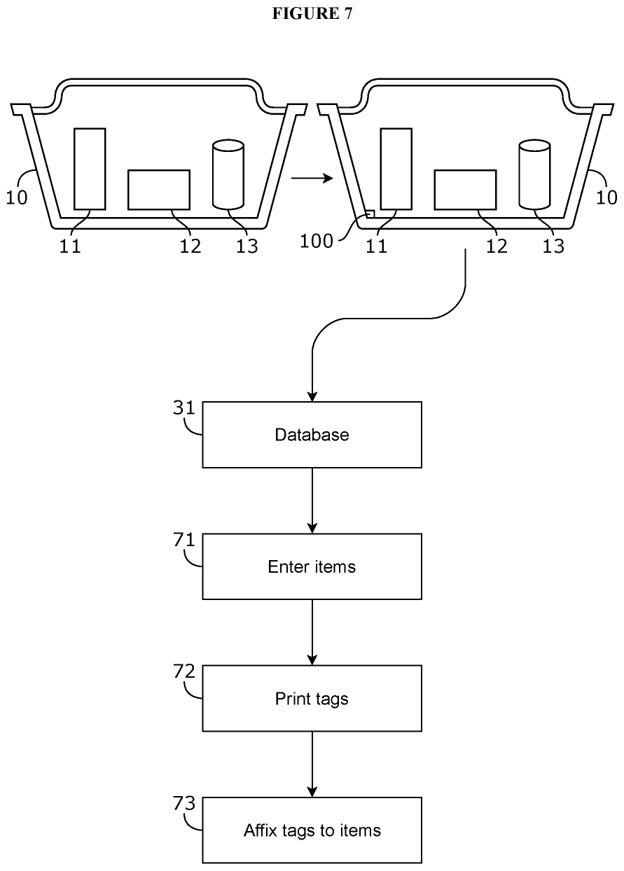

Alternatively, (e.g., FIG. 7) the box of goods (10) may be tagged with a lot number (100), wherein the lot number comprises all of the items within the box of goods (10), which allows the database to organize these items under that lot number. Once items are identified under a lot number, they can then be entered into the database and the system prints the tag number, e.g., (21, 22, or 23), to add to the items. This allows the system to enter the information first, and then create a tag number, which can be printed and affixed to the item at a later time.

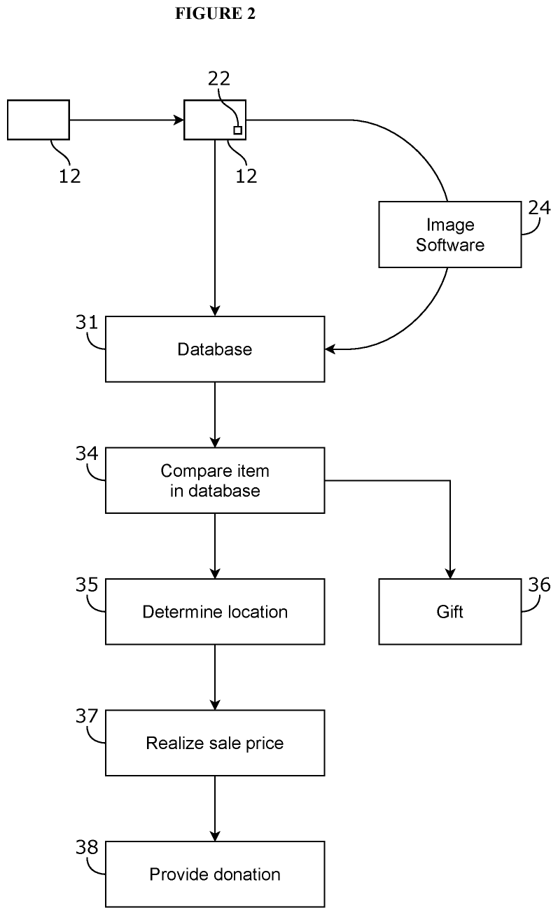

FIG. 2 provides additional details regarding this process and additional steps that may be useful for maximizing value of goods as well as providing for gifting of nonsaleable goods. As an item (12) is first donated, the addition of the tag (22) is essential to ensure that relevant data from the item (12) can be tracked. The tag (22) may be a relevant machine-readable code, with nonlimiting examples including: a barcode, QR code, RFID chip, or other machine-readable code that is affixed to each of the donated items in the lot. Once the item is tagged, the item is inventoried, and correlated to the donor and charity information in the database. In certain embodiments, the item is further photographed, and an image is stored within the database. A separate record is created in the database for each item. The record contains details about the item such as category (for example, clothing, accessories, home goods, electronics, media, etc.), specific type of item in the category (for example, jeans, t-shirt, dress, sweater, jacket), details about the item such as brand name, color, size, quantity, as well as information regarding the quality or condition of the item. This information can be manually entered into the database, or it can be automatically populated using image recognition software that analyzes the photograph of the item and populates the database with details. Finally, the tag itself may have the relevant data and information present on the tag, whether in a machine-readable code or another format.

The database contains a record for each item donated to and sold from the thrift shop. Where multiple businesses use the database, all such records can be queried or parsed as appropriate based on search criteria within the database, which creates a larger data set. The individual item record contains information such as location at which the donation was made, initial sales price for the item, location from which the item was sold, total number of days between receipt of the item and sale of the item, final sales price, as nonlimiting examples. The robust data stored in the database allows the system to predict larger trends. For example, brand name jeans on the retail floor of a thrift store in a metropolitan city in the northeastern United States, on average may sell in 45 days and for $10.00. However, brand name jeans on the retail floor of a thrift store in a rural town in the midwestern United States, on average may sell in fifteen days and for $25.00. The system is also able to query commercially available databases that provide retail prices for various products. For example, the commercial database might show that in 2021 new brand name jeans on average retail for $50.00 per pair. Likewise, the system will be able to query databases that provide fair market value for antiques, vintage, and specialty items which may command a greater retail value than items sold in a thrift store and should instead be sold at a specialty store. Such databases can be accessed through API related to said database. Access to such databases can be purchased or provided by the owner, or datasets can be created by mining the data or purchasing the data and stored within local servers.

In a preferred embodiment, it is useful to manage sales prices based on a goal number of days on the market premise. Meaning, an item should be priced so that it sells within a predetermined number of days, or within a predetermined range of days. This goal number of days on the market is not taken as a single number but is also dependent on the price of the item. In the simplest terms, a lower priced item should have a lower number of days on the market than a higher priced item. Taking a single example, a string bracelet being sold for $0.99 may have a goal number of days on the market of 14 days, while a designer dress being priced at $199.00 may have a goal number of days on the market of 50 days. In each case, the relative number of days and the sale price are correlated.

An example calculation may be as follows: A blue T-shirt from BEST brand, size medium. The computer system calculates a price based on the following factors, which can be generated from data within the database: the average current market price of a woman's shirt is $5.50; T-shirts sell for 35% less than all women's shirts; a BEST brand shirt sells for 10% more than the average shirt; and a blue item sells for 15% more than the average shirt. Thus, taking the price of $5.50×$0.65×$1.10×$1.15=$4.52. This provides an estimate for a first price for the blue T-shirt. It may then be appropriate, depending on the system to modify the price up or down to fit within a pricing bracket, such as a $4.00 or $5.00 item, to create simplicity in the pricing models.

Then, the predicted price, here $4.52, is compared to the current market conditions (meaning how fast items are selling) for the item. This predicted price can be adjusted based on the current market conditions, based on sales trends of the goods based on the total days it takes to sell an item. Where an item sits for more than the goal number of days on the market, the item was overpriced. By comparison, when an item sits for less than the goal number of days on the market, the item was underpriced. Taking a few estimated variables, we can adjust the price based on the current market conditions. Here, the days on the goal number of days on the market is set at a base of 40 days for an item, with a “days on market” factor (DOM factor) of 0.5, and a price adjustment of $0.01 per day. Meaning, the price would be adjusted by $0.01 for each day above or below the goal number of days on market.

An example of the above shows the following:

An item such as a blue T-shirt with a price of $4.99 is calculated as ($4.99÷0.5)+40 to determine its goal number of days on the market. Thus, the goal number of days on the market would be 49.98 days or approximately 50 days. We then look at the actual number of days that the product sold. In the example, the T-shirt sold in 22 days. Thus, it was essentially 28 days under the goal number of days on market. We would then adjust the price up, with the new price being adjusted $0.01 for each day, or an adjustment of $0.28, yielding a new price (for a new similar item) to be at $5.27 instead of $4.99. The specific price adjustment, the base number of days on market and DOM factor can be adjusted based on whether smaller or larger changes in price are desired. Thus, the examples herein are merely exemplary, and the embodiments may desire wholly different values for the given variables. Finally, in certain instances, different classes of goods may have different variables. For example, women's clothing may have one goal number of days on market, and pricing variable, while men's clothing may have a different goal number of days on market and a second and different pricing variable.

While the pricing can be easily adjusted for newly priced items, a key element is that the data can be continuously updating as sales occur to modify prices in real time. Indeed, this is a key element of the model, as changes to the market may be, in some cases, swift, and it is possible to entirely miss the market changes if prices are not dynamically modified.

In certain applications, it may be suitable to use image recognition software (24) to identify the relevant characteristics of the item to assist with data entry and thus pricing. Thus, the items can be tagged and then an image taken, via still or video, to capture the item data. It may be necessary to both use the image software and to also provide further details, such as size, condition, brand, etc., if these features are not recognizable from the image software (24).

A variable within the system is based upon the ideal location to sell an item to maximize the sales price. In such an embodiment, instead of merely modifying the price based on the current market conditions, a further analysis includes whether a different location (minus expenses to move the item to such location) would yield a greater return. Accordingly, upon a complete entry into the database (31), the system compares the item to others within the database (34). To do this, the system queries the database for the particular item and determines the predicted price, as detailed above, for which the item can be sold if it stays at the current store location. For example, the query may compare all known examples of the same item, or of all similar items within a class, for example women's T-shirts, or men's dress shirts, etc. In further embodiments, the comparing step may further include a populated database, or a generated database that is generated from machine learning. Other databases may be populated through API that gather information from Web listings at retail locations, secondhand Web listings, online auction sites, online forums, etc., in which the item might appear for sale. These features allow for the creation of a much larger database to gather more precise data on given items. This may be specifically important when some items are from obscure brands or are unique sizes. Such variables are difficult to price from a limited dataset, and thus a larger dataset allows for better accuracy with regard to pricing at a national level, instead of within the single store.

Thus, using the larger database and location parameters, it may be suitable to also determine location-based sale criteria. In such a case, the system also queries the database to determine the predicted price (retail value) for which the item can be sold at all other geographic locations that subscribe to the system. Thus, if an item is located in Houston, Tex., but may have more value in Miami, Fla., then an analysis can be performed as to moving the item to the higher priced location to generate a better realized sale price.

In certain instances, some items may have limited or no results for pricing. Thus, in preferred embodiments, the system queries one or more external databases to determine fair market value for antiques, vintage, or other specialty items with higher or unknown value. Such systems may use public databases, such as auction houses, which list sales prices for millions of items. Based upon the results of these queries, the system determines where the item can be sold for the greatest profits. Thus, the system determines a price based on a goal number of days on the market and optionally determines a location (35). If sale of the item will be most profitable at the store at which the item is donated, the item will remain at that location. If it is determined that the item has more value if sold at a vintage or antique store, the item will be priced accordingly and placed on a wholesale online marketplace for resale by a more suited retail location. If it is determined that the item can be sold for a higher price in a different geographic location, the item will be sent to that location for retail sale or placed on the marketplace. If the system queries the database and determines that the item is overstocked at the thrift store location at which the donation was made, the system will determine an appropriate location in need of inventory and send the item to that location or hold the item to be stocked at a later time, as appropriate. Likewise, if the system queries the database and determines that an item does not typically sell, the system will recommend that the item be gifted (36) to a charitable organization who would make better use of the item. Finally, as detailed in FIG. 2, the item is sold and a sale price is realized (37), and then a donation is provided (38) to the nonprofit organization that was originally identified in by the donor. Optionally, a receipt can be provided to the donor to provide precise valuation of the donated item.

Indeed, a detail of this process is to identify goods that have a resale market, or have a sufficient value, based on the good and its condition, to be sold. If the good does not have sufficient value to be sold, then the items are collected, sorted by class, and gifted (36) directly to additional enterprises (or directly to those in need) of these particular items. Thus, waste is reduced or eliminated and provides direct gifting for certain goods. For example, a donation provides for used shoes, which are wearable but have a low sale value, and thus have no retail value at a secondhand store but may be happily received by a homeless shelter for free distribution. Similarly, linens or towels may be donated, which have no secondhand resale value but are then gifted to homeless shelters or animal shelters for use therein. These are merely examples of the types of goods that may be donated and that are determined to have little to no commercial resale value, but that have value within a community for certain populations.

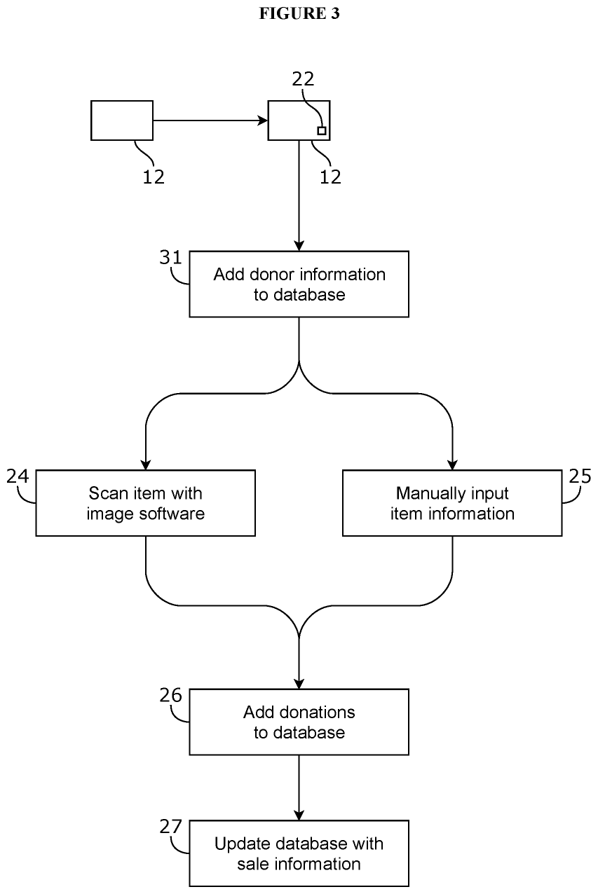

FIG. 3 provides further clarity with regard to the process of adding information to the database. The item (12) is provided with a tag (22), the donor information is optionally added to the database (31) when provided, and then either the item is scanned with image recognition software (24) or manually input (25) by a pricing expert or both in order to add (26), the rest of the information regarding the item (12) to the database. Upon the realization of a sale, the database (31) is updated with the sale information (27). Such steps are key to maintaining a complete sales record, tracking of the items, and building up data for the database to provide better guidance for future pricing of items.

Regardless of where the item is sold (at the donation location thrift store, at another network thrift store or on the wholesale marketplace) the system maintains a link between the item and the charity the donated item benefits. When the item is sold, a percentage (or all) of the profits as determined by the thrift store, are donated to the designated charity. A record of the sale price and items is provided to the charitable organization for their records. Optionally, if the donor information is collected and a receipt is desired, the donor is then provided an accurate accounting of their charitable donation. This allows for the most accurate form of donation receipt for both the charitable organization and in some cases the donor and allows for clear records of the value of the donated goods.

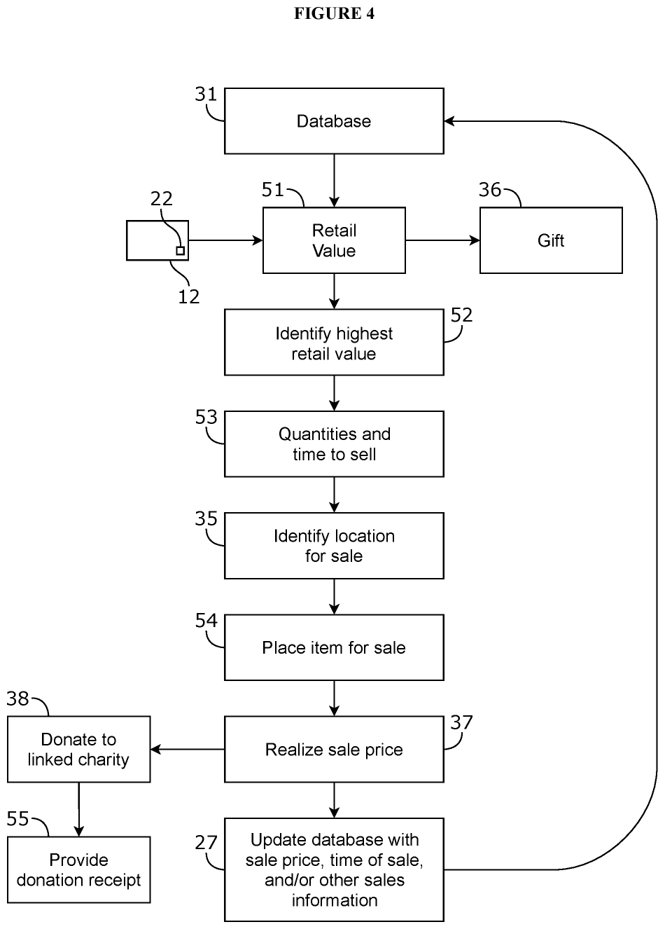

FIG. 4 takes many of these steps and combines them. An item (12) is donated, and a tag (22) added. This information is provided within a database (31). As a new item (12) is added, the predicted price (retail value) (51) can be checked against the database (31). The system performs a query upon the entry of the new item (12) into the database (31). The query looks at the item (12), compares the item (12) to those already in the database (31) and then parses information regarding the item (12). Thus, if there are 100 entries in the database (31) for a particular brand of jeans, there will be a strong sense of the sales price, the location for the best price, the time to sell (a goal number of days on the market), and what sizes, and condition or quality are best to sell. Thus, based on the query against the database (31), the system can identify the highest expected retail value (52), it can also identify the quantities and time to sell (53) of the items and identify a location of the item for sale (35), including whether a marketplace sale is the most appropriate.

Where an item is being sold also depends on the quantity of the same or similar item in that location. Again, the query and system are able to tell the quantity of goods at a particular location. Thus, if there are ten other jeans of the same size and brand, then it would likely increase the time to sell the item. However, if there are ten jeans of the same brand, but different sizes, then the item would likely be appropriate to ensure that a buyer would have access to a given size. Similarly, where there are dozens of other brands, but the same size, the system will be able to identify how that impacts the sales trends, i.e., the time to sell the inventory, to determine if a location is appropriate. Those of ordinary skill in the art recognize that items, for example, jeans, may need many different brands, as each may have a different fit or style that is appropriate for a particular consumer. Accordingly, instead of human intuition, the database can better identify the actual time to sell based on the quantities present in any one location. Thus, if a particular location has a lot of inventory of this item, it may make sense to send it to another location, if all things are otherwise the same (or similar) with regard to sales price, all of which is best defined by the sales information stored within the database.

However, some items do not have a strong or saleable value and thus would typically be thrown out or destroyed. However, the system defines relationships with other nonprofit entities to provide necessary and/or consumable goods to those in need, and thus certain items can be gifted (36) to such entities. The individual threshold for a donation item may be set by the individual donation location and may depend on a number of factors. Some items as low as ten cents may sell and be saleable. In other locations, items of less than $1 may be identified as a threshold for an item to be gifted. However, an inexpensive item, such as a friendship bracelet or headband, even if priced at fifty cents or a dollar, may be easily recorded and sold because they take up little space, have a short days on the market, and the system can simply list the inventory as one of x number of items, for example, which can be entered via a bulk entry format for efficiency (for example, a total of 100 bracelets can just be identified by a single item number and a quantity provided). Thus, the database and the query system can be modified to highlight the likely retail value (51) and to identify goods for donation (36) below a certain threshold. However, such threshold can be overridden as appropriate.

Once an item (12) is placed for sale (54), the information can be populated into the database (31) and once sold, the realized sale price (37) is provided. Thus, the database can be updated with such sales data (27), which may include, but is not limited to sale price, time of sale, location of item, location of item within a store (e.g., at the cash register, warehouse, or placed on a shelf). This sales data (27) is then utilized to provide for better future pricing and/or to assist with dynamic pricing of items within the system, as it can be used to modify the goal number of days on the market and thus modify pricing of similar items. Additional information that may be included such as who priced the item, who merchandised the item, and other measures that may provide for accountability and productivity for employees. Those of ordinary skill in the art recognize that sales are made both on needs and wants, and that placing items in places where there is an emotional attachment to them can produce greater responses and thus purchase rates than in another location. Accordingly, such information may be highly relevant to ensuring that the highest sales prices is realized of an item.

Once the price is realized, the donation is made to the linked charity (38). In certain embodiments, it is advantageous to wait to make the donation to a linked charity until a certain dollar threshold is reached, for example, twenty, fifty, one hundred dollars, or another amount as determined by each location and the given charity. To the extent that donor information has been obtained and a receipt is requested by the donor, then a donation receipt is provided to the donor (55). This process can then be repeated with all other donated items (12).

Frequently, items within a store are scanned by an employee to check data on the given item. For example, a first T-shirt with a $4.99 price is scanned and shows it has been for sale for 15 days, and the $4.99 price has a goal number of days on the market of 40 days. The price does not need to be adjusted. A second winter jacket is priced at $29.99 and has a goal number of days on the market of 65 days, but upon scanning, shows it has already been on the market for 90 days. The winter jacket can then have the price modified, by taking the price and the current market conditions into consideration (i.e., it is 25 days past the goal number of days on the market), and a revised tag is created with a new price that is modified down to $19.99 in order to encourage the sale of the item based on the market conditions. The scan can also be used to assign an item type (so the store can pull an inventory report and know how much of a given class of goods need to restock), to assign merchandiser (to assess worker productivity), and to edit other parts of the item like its description. Thus, such process of scanning can aid in several aspects within the business.

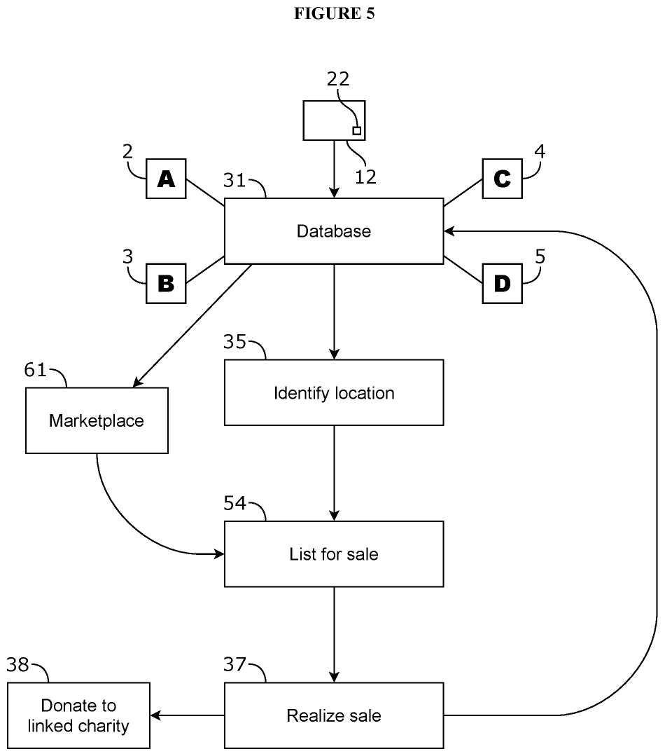

Similarly, prices can be updated of individual items as the market conditions change. Because the items are catalogued, dynamic pricing can be provided. If items are selling quickly at a store, the average price may be increased within the database. For items that are on the marketplace and not yet sold, such items may dynamically be priced up or down so as to ensure they are listed at an appropriate price to account for market conditions and market pricing. Scanning of tags can then modify pricing by creating a new tag and a new price listed on the tag or modifying the tag in some other way to modify the price upon scanning of the tag for sale. As datasets increase in size, the reliability of the dataset also increases, and thus, selling items to realize a highest sale price may inevitably occur outside of the physical store, such as within an online marketplace. This concept of providing a centralized marketplace is further detailed in FIG. 5.

FIG. 5 details that the system is defined to contain a series of stores, both those owned directly by a donation location as well as those who subscribe to a wholesale marketplace to utilize the software and system solution to purchase goods for resale that are maximized for profits based on the information within the database.

For example, the donation location may contain one or more owned storefronts A, B, C, and D (2, 3, 4, and 5) that directly sell goods that are received at the donation location. The system, however, can utilize the information within the database (31) to identify if the item (12) received at the donation location would sell for more money at a different owned storefront. Thus, the system can identify the quantity of similar goods at each of the various locations and simultaneously determine the average days to sale and the average sale price of the goods, to then maximize the final sale price of the donated good. This, in turn, maximizes the value of the donation, or even for profitable business, to maximize profit. One aspect of dynamic pricing is the amount of lookback that is utilized in determining the movement of the average sales price. For example, while all sales data (corresponding to a particular keyword or particular item) can be used, extremely large data sets are unlikely to show any trends in the marketplace. By contrast, using a moving dataset looking back 30 days, 15 days, 10 days, 7 days, 3 days, 1 day, and even as short as one hour, can provide more immediate and meaningful data sets that show movement of the average sale price. Similarly, the data can show the entire average sale price and then a moving 30-day, 15-day, 10-day, 7-day, 3-day, or 1-day moving average. Use of these smaller data sets for the average sale price is more useful when dynamic pricing.

FIG. 7 details the concept of a box (10) comprising items (11 and 12), wherein the box is provided with a lot number (100), for the goods. The database (31) then allows for entry of the items (71), regardless of how many are within the lot, and upon entry into the database (31), the system can automatically create a tag, e.g., a barcode and print the tag (72) and affix the tag to the item (73).

The system, however, in certain embodiments may comprise a wholesale marketplace of subscribers who can purchase items through the wholesale marketplace. This wholesale marketplace further includes information regarding the particular item to allow for users on the wholesale marketplace to identify goods that will be maximized for sale at their particular location. This wholesale marketplace allows for secondhand shops to find items of interest for their location without needing to “pick” or otherwise find their own secondhand goods. A benefit of this marketplace (61) is that it is tied directly to the database (31). Thus, as pricing is changed within the database, either up or down, the price on the marketplace can be similarly modified. Thus, use of dynamic pricing as detailed above can be implemented to manage the inventory and return on the items within the wholesale marketplace

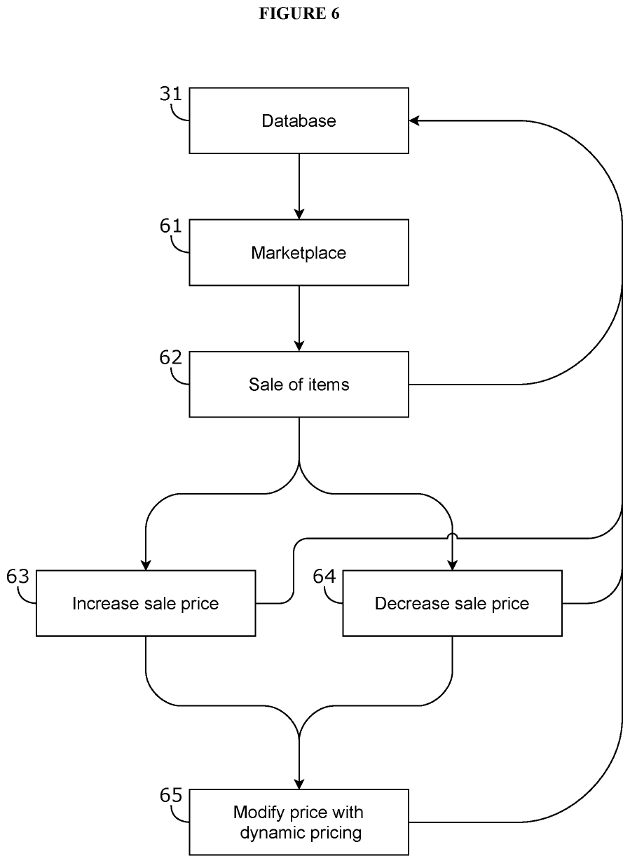

An example would be as summer approaches, a heat wave is expected, and shorts and tank top clothes are selling rapidly, while winter clothes are not selling. As x number of goods are sold, the price of the tank tops and shorts is increased because demand is higher and supply is lower. This can be detailed by the reduced days on the market, which in turn provides a modified price target for the items based on the goal number of days on the market feature. FIG. 6 details this where the database (31) is continually provided with information from the marketplace (61) as well as the sale of items (62). Thus, as the increase in sales price (63) is identified (either by the direct sales numbers, or through a price adjustment based on a revised price calculated because of the goal number of days on the market target), the dynamic pricing at the marketplace (61) can be increased. If there is a decrease in the sales price (64), or goods are taking longer than the goal number of days on the market, then a decrease in the dynamic pricing can be generated at the marketplace (61). Thus, the marketplace can be modified with the dynamic pricing (65).

To the extent possible, items at a retail store, even those tagged with a paper price can be modified with this dynamic pricing as desired, which allows for modification of the price in the database or printing of a new label. If such prices are known to be increasing or decreasing, steps to change the price can be implemented. For example, prices may start off as being “on sale” which is a normal base price. For example, shorts are priced at 20% off, with a $10 sticker price and usually at $8 with the 20% off. If the prices are increased, the discount or “sale” of 20% can be removed, to price the item at $10 instead of $8. Conversely, if winter hits, and the price needs to decrease, items can be further discounted, e.g., to 50% or 75% off or more to close out inventory. This allows a store front or the marketplace (61) to modify prices dynamically (65) with dynamic pricing. Scanning of tags for one or more items can reveal the price, the days on the market, and a new or replacement tag can be printed and affixed to modify price. Furthermore, the system, after scanning, can identify that a product is overpriced or underpriced and suggest a revised price. For a reduced price, affixing a colored tag or percent discount tag is a simple way to identify goods on sale at a reduced price. Where prices increase, new tags may be printed and applied.

In a further example, pricing may be determined by a symbol or a color. Thus, red items are $1, blue items are $3, orange items are $5, and so on. A different symbol may be utilized instead of the color. This will allow groupings of similar items and identical pricing to be modified without having to change the tag. The store may just state, “all red items are 50% off today”, which in practice has changed the price from $1 to $0.50. Such information is easily provided by signage within a store to reflect the same. Pricing can thus be adjusted without having to modify an attached tag.

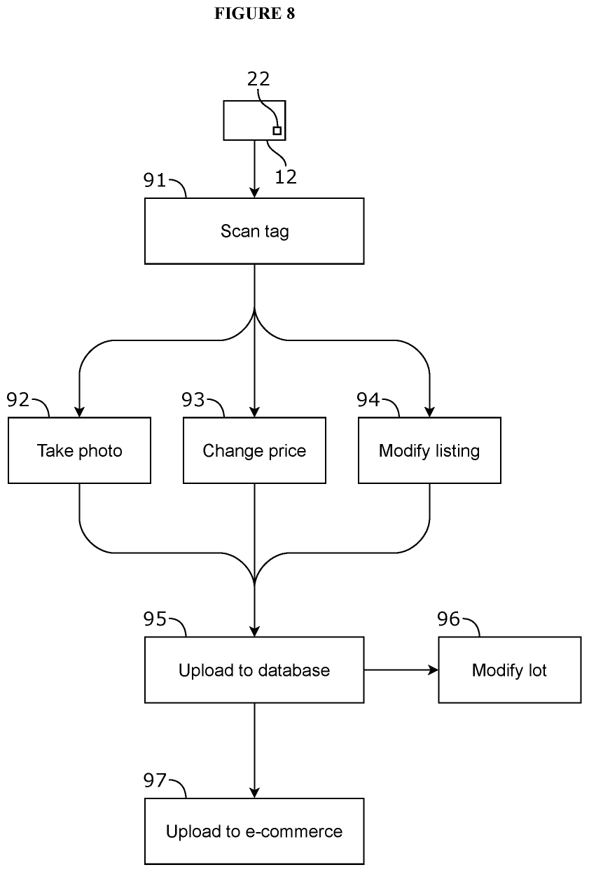

Once items are tagged and ready for sale, as detailed above with dynamic pricing, it is easy to modify price or perform some other action by scanning the individual tag (22). FIG. 8 details that an item (12), with a tag (22) can be scanned (91). The scanner can be any one of a variety of scanners capable of reading the particular machine-readable code related to the tag (22). Thus, a barcode scanner for a barcode, a near field communication scanner for NFC tags, or a blue tooth scanner for a Bluetooth low energy tag, as nonlimiting examples. Once the tag is scanned, the database (31) can be accessed and actions taken, including but not limited to taking a photo (92), changing a price (93), and modifying a listing (94). The scan may prompt a graphical user interface (GUI) to perform these features, such as to allow for entry or modification of the records or modify the listing (94) to show that actual time the item is being placed for sale on a sales floor. Thus, when an item has been first donated, then catalogued, it may still be days or weeks before it hits its final location to be sold, and even then, it may not get into circulation for sale until there is time and space to display the item. Thus, by scanning the tag, we can quickly and efficiently update the entry in the database (31) to identify the actual time it is placed on a merchandise floor for sale. This provides much more accurate information regarding the time it takes to sell the item than if the information is not accurately provided. The modification of the listing (94), by identifying its time for sale, is uploaded into the database (95). Other modifications can occur, including a change in price (93) or modify the lot (96) as a whole. The change in price (93) is either a change up or down. As provided in other examples as demand increases and quantities decrease, prices may go up. Similarly, as demand decreases and/or quantities increase, a reduction in price may be necessary to sell the item. By scanning the tag, a price change can be uploaded to the database (95). This allows for a simple way to make price changes to a tagged item.

In other instances, both a change can be made to the database (31), but also a change in the tag can be provided, such as a change in the price (93), where the scanner or system provide for newly printed labels with the updated sales information. In other cases, as a nonlimiting example, a note may be provided that “all items on this table are 50% off, discount taken at register.” And, instead of marking all tags with a new price, the price will be reflected based on the changed price (93) which is modified in the database (31). These changes can then be uploaded to the e-commerce site (97) to reflect the changes.

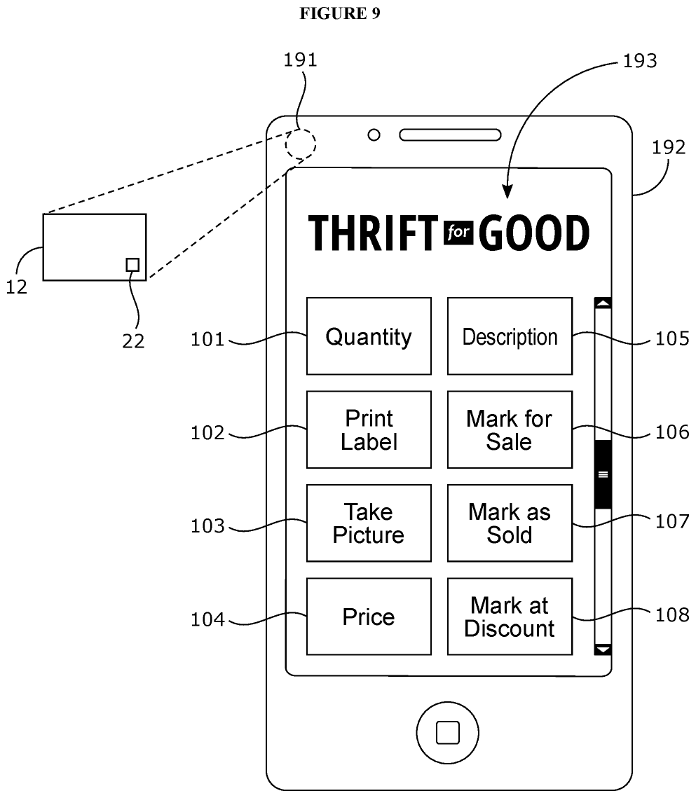

The system is also defined to increase the efficiency within e-commerce spaces. Indeed, e-commerce almost always requires pictures to sell an item. Typically, it takes several minutes to take a photo (92) and upload it to a database or server, for storage and then link it to the appropriate location in an e-commerce site that allows for the correct picture to go with the correct item. The system here defines a GUI instead, as depicted in FIG. 9, and the database allows a camera (191) or other reader on a mobile computer (192) such as a mobile phone, to scan the tag (22) on the item (12), which pulls up a record related to the item. The GUI (193) provides several actionable or visual components to provide information to the user, or to add information regarding the item (12) to the database. The GUI can provide the quantity of items (101), print a label (102), take a picture (103), show the price (104), provide a description (105), mark an item for sale (106), mark the item as sold (107), and mark for discounts (108), as nonlimiting examples of actions possible on the GUI. For example, the GUI asks whether to take a picture (103), by use of the camera (191) or the user can utilize a stock image, or other solution if an image is desired. In the case of taking a photo, the user can snap the photo, and upload the photo into the database entry for that item, which can be directly linked to the e-commerce site. This allows for items to be rapidly catalogued for e-commerce sale in a way that was not possible heretofore. Indeed, prior methods of taking photos often require five minutes per item, a time which is fine for high price items, but not realistic for items at lower prices, such as below five or ten dollars. Accordingly, by reducing the time for image/photo catalogue of items to mere seconds, we can more efficiently capture these images and manage and populate an e-commerce site. Furthermore, by increasing the number of photos within the database, it is more efficient to use image recognition and neural learning to generate data sets to be able to allow for AI to determine certain aspects from an image.

In a simple implementation, where it is determined that an item or group of items needs to change a price, by scanning one tag or a plurality of tags, the price can be modified with a generic phone or other scanning device. The price can be modified and saved into the database, and in some instances a new tag printed for clarity of the price on the items. Indeed, it is preferable that a scanning device simply be a smart phone or other ordinary device and not a specialized device. The smartphone possesses the necessary camera and connectivity to run software, engage with the database and utilize the GUI to take images and update the database to post items into the system. Accordingly, the systems described herein contain a database (31), a scanning device, software run on a computer implemented system, which can perform the steps outlined herein via code to run queries and to modify listings and other elements as described throughout the description of the system.

Furthermore, the system can be utilized in a standalone platform with an individual store or a series of stores, separate from the remaining inventory that may or may not be generally on a database. In this instance, a self-contained system can be utilized wherein the database (31) is accessible for pricing needs, i.e., it serves as the foundations for neural learning and pricing, but a user can have their own separate database for their inventory. This allows for all of the efficiency gains for pricing, image taking, modifications of records, etc., that are aspects of the system, to be held by a single store or series of stores. Thus, the system can be implemented as package of software using one or more servers and machine-readable code reading devices to implement the various methods for increases in productivity.

### EXAMPLES

Jane takes a box of items to her local thrift store in Hurst, Tex., for donation. The box contains a pair of Calvin Klein® jeans, some vinyl records, a set of Cuisinart® pots, four dinner plates, and new shorts. In this embodiment, regardless of whether a batch code is attached to a box of donations, ultimately, a tag is affixed to each item in the box for entry into the database. The barcode is coded in the database to recognize Jane as the donor for each item and to indicate that Jane's designated charity, Save the Whales, will receive proceeds from the sale of any of the items. The Calvin Klein® jeans are entered into the system either via manual data entry or via image recognition from a photograph of the jeans. The system queries the thrift store database and determines that the average sale price for Calvin Klein® jeans at the Hurst location is $15 and it takes an average of 30 days to sell. The system then compares that data to the data for Calvin Klein® jean sales in thrift stores across all geographic locations. The system determines that the same jeans sell for an average of $25 at locations in Austin, Tex. and Jacksonville, Fla., in an average of 15 days. The system then queries the inventory database and determines that the thrift store in Austin is fully stocked with Calvin Klein® jeans but the thrift store in Jacksonville only has one pair in stock. The system determines that Jane's donation will generate the most revenue in Jacksonville and the jeans are sent to that thrift store in that location to maximize the sale. Once the jeans are sold, the system knows to send 25% of the revenue, the amount determined by the thrift store, to Jane's designated charity, Save the Whales.

Next, the vinyl record titles are entered into the system either manually or via image recognition. The system queries the database and determines that records retail for $10 at the Hurst, Tex., thrift store. The system then queries an external database with fair market value prices for vinyl records and determines that the record titles retail in record stores for $35 per album. The system recognizes that the records would generate more revenue if sold at a record shop so rather than placing the records in the inventory for the Hurst thrift store, the system lists them on the wholesale marketplace for $25 (in order to allow the buyer to also profit at the higher price of $35). Once the records are sold, the system knows to send 25% of the revenue, the amount determined by the thrift store, to Jane's designated charity, Save the Whales.

Next, the Cuisinart® pots are entered into the system either manually or via image recognition. The system queries the database and determines that Cuisinart® pots sell quickly at the Hurst, Tex., location with the last sale being a year ago for $10 per pot. The system then queries an external database of retail prices for various goods and determines that the retail price for new Cuisinart® pots has increased 30% over the past year. The system recommends that the Cuisinart® pots be listed for sale at the Hurst thrift store location for 30% more than the previous retail price in order to maintain a goal number of days on the market of thirty days, as selected as the target days for that price point at that location. Once the Cuisinart® pots are sold, the system knows to send 25% of the revenue, the amount determined by the thrift store, to Jane's designated charity, Save the Whales.

The plates are entered into the system either manually or via image recognition. The system determines that there is no market for four plates at any of the thrift store retail location. The system then identifies a charity in the Hurst, Tex., area that accepts gifts of kitchen items for low-income families. Typically, a grouping of such items would be given to a charity, where the charity would accept, for example, a box of four plates. At the charity and donation level, the precise definition of each item is not required, but the macro level of “four plates” would be desired.

The shorts are entered into the system either manually or via image recognition. The system determines that there is a strong market for the shorts, with the highest sale price being on the marketplace at $10. The particular shorts are listed to the marketplace and are not sold for two days. During those two days, shorts are rapidly selling at other locations and the time between the item being placed for sale and the sale being realized decreases rapidly and so does the inventory at stores. The database and system recognize that the recent sales have increased the price of shorts and the price of the shorts on the marketplace are dynamically raised by a dollar to $11. The shorts are later sold that day for $11 on the marketplace and the extra dollar is realized due to the dynamic pricing.

This calculation can be determined, for example, by taking the base number of days on the market, with the goal number of days on the market determined by the base price of $10. The price, therefore, can be adjusted upwards, because the shorts are selling at a time that is much lower than the goal number of days on market. Thus, by adjusting the price up, we can expect to revert closer to the goal number of days on the market and obtain the higher selling price for the item.

Thus, an example of the above is a method for dynamically pricing goods wherein the method includes a database containing a list of price entries within the database, e.g., a list of shorts being sold or having sold within the marketplace. The shorts contain at least one keyword, such as “shorts” or the keyword can be a brand, or a style, such as: swimshorts, workout shorts, athletic shorts, etc. The database comprising at least one keyword to group similar items in the various entries within the database. When a new item is entered, creating a new entry for an item comprising a keyword for said item, e.g., “shorts.” To then dynamically price the shorts, performing a search within the database on the keyword of the item and returning a sale price and a location for said item, which allows for pricing said item. Upon a subsequent query of the system, or upon a sale of an item having that keyword, updating the search regarding said keyword on a dynamic basis, wherein upon a variation of an average sale price of more than a predefined amount, modifying the price of said item. Here, using a moving average sale price, e.g., as between 1 hour and 30 days, provides a more meaningful look at the data corresponding to the current market conditions. Thus, the average sale price is preferably used to determine more recent sales, or a moving average as compared to the historical average sale price. In certain embodiments, the price is only modified when the average sale price moves more than a predetermined amount, for example more than 1% to more than 50% of the average sale price. This eliminates outlier data, should certain items sell quickly or at an inflated price without more. This modification can also come from a variance in the goal number of days on the market so as to then modify the price.

In another example, a variation of the above comprises wherein a box of items is donated to a location. The box, and not the items, is tagged with a lot number. All items within the donated box are identified with a charitable organization. The box with the lot number is then catalogued at a later time. For example, a few days later, the box is sorted, by software or by manual review. At this time, all items may be identified and stored in the database, or a first pass may be generated to remove certain items if they are to be gifted. Both a manual and a software solution can identify certain goods for donation. Goods to be donated can then be directly placed to be gifted to an appropriate charity if the charitable organization of the donor's choice is not appropriate for the items.

After items for donation are identified and separated, the remaining items are identified in a donor batch, with all items being part of that donor batch. The description of each item is generated and placed into the database and then an item tag is individually printed for each item and placed on the individual items to be sold. This way, the system and database comprise a batch information related to a donor, with the donor information corresponding to the batch being an optional feature, as some individuals may not want to identify themselves. Once the items are then individually tagged, the remaining steps of identifying their location to be sold can be finalized and the items placed for sale at the appropriate location, and once the sale is realized, the information on the sale conditions can be updated to continue to propagate the database with information.

As detailed in the embodiments, efficiency in the pricing, merchandising, and processing of items is critical. However, pricing is always paramount to ensure the greatest return. Therefore, a method of dynamic pricing for an item comprises several steps, which comprise constants to meet conditions for the store and market conditions. The method includes creating an entry within a database corresponding to a first item that is being logged from a donation (or just an item being merchandised or cataloged into the system). The database contains other items, and common keywords to ensure that the first item can be compared to the other items in the database. From here, one can calculate the average price and days on the market for each of the other items in the database to generate an estimated price of the first item (the new item).

Now we can better price this item based on a goal number of days on the market using a number of days on the market constant of between 1 and 60 days as the base amount of time each item should be on the market in the given store. Then the days can be modified based on a pricing factor, preferably between 0.1 days and 10 days. Thus, multiplying the price of the item, such as $10 times a constant (e.g., 5 days), would yield 50 days. Thus, if the goal days on the market was 1 day, you would add 50 days to this to generate 51 days as the goal. The price set is then intended to sell the product in about 51 days, usually with a range of 7 days to 14 days on either side of this estimated date.

Then, we look at the days the other items in the database took to sell and see if these are above or below the now calculated 51 days. If they sold faster, the price should be higher, if they sold slower, the price should be lower. The value above or below then is determined by taking this difference in days, e.g., the goal days was 51 days and the items in the database sold in 21 days, leaving a difference of 30 days. We would multiply the 30 days times the pricing constant (typically between 1% and 50% of the value of the goods in the store). For example, a pricing constant of 1% with average price of $5 yields a constant of $0.05, and thus 30 days difference times $0.05 would yield a change in price of $1.50. Thus, the price as calculated should be raised by $1.50 from the original calculated price. The various constants and the prices can be modified daily, weekly, or as necessary to keep up with the changing market conditions for the sale of these items.

The scanning of a tag (21, 22, or 21), which is shown in several of the figures and throughout the embodiments may be performed by any type of computer such as a laptop computer, desktop computer, tablet, and the like, but most preferably through a handheld computer (e.g., phone, smartphone, tablet, personal digital assistant), wearable computer (e.g., watch, glasses), or portable computers (e.g., laptop, netbooks). Scanning of the tag (21, 22, or 23) from the scanning device is performed through near-field communication (NFC) or use of a camera on the user device to scan the tag (21, 22, or 23) in whatever form it is applied. The handheld computer or other device used to perform the scan typically include a browser application to facilitate communications with one or more servers among other things.

The server and back end of the system may each be a general-purpose computer. Thus, each computer includes the appropriate hardware, firmware, and software to enable the computer to function as intended and as needed to implement features detailed herein. For example, a general-purpose computer may include, without limitation, a chipset, processor, memory, storage, graphics subsystem, and applications. The chipset may provide communication among the processor, memory, storage, graphics subsystem, and applications. The processor may be any processing unit, processor, or instruction set computers or processors as is known in the art. For example, the processor may be an instruction set based computer or processor (e.g., x86 instruction set compatible processor), dual/multicore processors, dual/multicore mobile processors, or any other microprocessing or central processing unit (CPU). Likewise, the memory may be any suitable memory device such as random-access memory (RAM), dynamic random-access memory (DRAM), or static RAM (SRAM), without limitation. The processor together with at least the memory may implement system and application software including instructions, including methods, disclosed herein. Examples of suitable storage includes magnetic disk drives, optical disk drives, tape drives, an internal storage device, an attached storage device, flash memory, hard drives, and/or solid-state drives (SSD), although embodiments are not so limited.

In an embodiment, the servers may include database server functionality to manage database (31) or another database. Although not shown, infrastructure variations may allow for database (31) to have a dedicated database server machine. Database (31) and any other database may be any suitable database such as hierarchical, network, relational, object-oriented, multimodal, nonrelational, self-driving, intelligent, and/or cloud based to name a few examples. Although a single database (31) is shown in the various figures, in embodiments database (31) may comprise more than one database, the more than one database may be distributed across many locations, and data may be redundantly recorded in the more than one database. Furthermore, data may be stored in blocks that are part of a chronological blockchain and may be dispersed across a decentralized distributed ledger. Blocks of data in a blockchain are linked in such a way that tampering with one block breaks the chain. Thus, digital data stored in a blockchain is verifiable with an elevated level of integrity. Therefore, the database (31) may also be a distributed database system, utilizing blockchain to provide for storage or security related to the system. As with any distributed database, the number of databases and particular nature of the blockchain storage is dependent on the particular exchange or blockchain as one nonlimiting example.

In certain embodiments, a location is desired, and the particular location is determined by GPS or by a geofence related to the position of the device. Furthermore, time may be a timestamp generated by the software or from the hardware systems and each can be entered into the database (31) when entry of information is provided therein.

It will be appreciated that the embodiments and illustrations described herein are provided by way of example, and that the present invention is not limited to what has been particularly disclosed. Rather, the scope of the present invention includes both combinations and sub combinations of the various features described above, as well as variations and modifications thereof that would occur to persons skilled in the art upon reading the forgoing description and that are not disclosed in the prior art. Therefore, the various systems and methods may include one or all of the limitations of an embodiment, be performed in any order, or may combine limitations from different embodiments, as would be understood by those implementing the various methods and systems detailed herein.

What is claimed is:

1. A system for dynamic pricing of secondhand goods comprising:
a database comprising a plurality of entries;
a tag corresponding to an item;
a software capable of comparing the item to the plurality of entries within the database and providing a goal number of days on market and a price to meet said goal number of days on market; and
placing an item for sale and dynamically raising or lowering the price of the item for sale as information in the database is modified.

2. The system of claim 1 wherein dynamically raising or lowering the price of the item for sale is performed by a process comprising:
a. comparing the goal number of days on market to an actual number of days on market from at least one sale within the database;
b. determining a difference between the goal number of days on market and the actual number of days on market;
c. taking the difference between the goal number of days on market and the actual number of days on market and multiplying the difference by a price factor to yield a price modification figure; and
d. modifying the price by the price modification figure.

3. The system of claim 1 wherein the goal number of days on market is defined as a number between 1 day and 365 days; and wherein the goal number of days on market is determined by a base number of days on market added to the price and multiplied by a factor of days on market to yield the goal number of days on market.

4. The system of any one of claim 1 wherein an adjustment based on the dynamic pricing is made based upon a sale being above or below the goal number of days on market.

5. The system of claim 1 wherein the dynamic pricing is modified by an adjustment value multiplied by a number of days separated from the goal number of days on market and then added or subtracted from the price.

6. The system of claim 1 wherein the system further defines a location for placing the item for sale.

7. The system of claim 6 wherein the location is within a single store.

8. The system of claim 6 wherein the location is an online marketplace.

9. A method for dynamically pricing goods comprising:
a. creating a new database entry within a database for an item, said database entry comprising a keyword related to said item;
b. performing a search within the database for the keyword of the item, said database comprising at least a sale price and a value corresponding to a number of days on market for each database entry;
c. returning a target sale price for said item;
d. pricing said item; and
e. upon passage of time, rerunning the search regarding said keyword on a dynamic basis wherein upon a variation of a sale price or the number of days on market, modifying the price of the item.

10. The method of claim 9 wherein the keyword defines a grouping of similar items and an average sale price to be used in calculating the target sale price.

11. The method of claim 10 wherein a modification of the average sale price of more than a predetermined amount modifies the pricing of said item.

12. The method of claim 11 wherein the predetermined amount is between 1% of the sale price of the item and 50% of the sale price of the item.

13. The method of claim 11 wherein the predetermined amount is calculated based upon sales from between 1 hour and 30 days.

14. The method of claim 13 wherein the predetermined amount is calculated based upon sales from between 1 day and 15 days.

15. The method of claim 9 further comprising modifying the sale price of an unsold item within the database that comprises the same keyword.

16. The method of claim 9 further comprising a tag on said item.

17. The method of claim 16 further comprising wherein the database is accessible by scanning the tag on said item; and scanning the tag on said item to access said database and modifying the sale price within the database.

18. The method of claim 17 further comprising printing a new tag with the modified sale price and affixing the new tag to the item.

19. The method of claim 16 further comprising scanning said tag, taking a photo of said item, and uploading the photo of said item to said database.

20. The method of claim 19 wherein the photo in said database is linked to an e-commerce Web site, wherein upon uploading of the photo into the database the photo is visible on said e-commerce Web site.

21. The method of claim 20 wherein the taking of a photo is performed via a GUI that uploads the photo into the database corresponding to the tag on the item.

22. A method of dynamic pricing for an item comprising:
a. creating an entry within a database corresponding to a first item;
b. said database comprising at least one second item, wherein said first item and said at least one second item comprise a common keyword within each respective database entry;
c. determining from the database an average sale price and a number of days on market for the at least one second item;
d. calculating at least an initial sale price based on the average sale price of the at least one second item;
e. determining a goal number of days on market by calculating a base number of days on market constant plus a product of the sale price and a factor of days;
f. comparing the determined goal number of days on market to an actual number of days on market for the at least one second item;
g. modifying the sale price of a product by summing the price with the product of a difference between the determined goal number of days on market and the actual number of days on market for the at least one second item and a pricing constant; and
h. placing the item for sale at the modified sale price.
